(19) United States
(12) Patent Application Publication
(10) Pub. No.: US 2023/0066022 A1
(43) Pub. Date: Mar. 2, 2023

(54) NEAR-INFRARED ABSORBING GLASS AND NEAR-INFRARED CUT-OFF FILTER

(71) Applicant: PLATINUM OPTICS TECHNOLOGY INC., Taoyuan City (TW)

(72) Inventors: Chung-Han Lu, Taoyuan City (TW); Che-Yu Chen, Taoyuan City (TW); Ming-Jui Yang, Taoyuan City (TW)

(21) Appl. No.: 17/894,204

(22) Filed: Aug. 24, 2022

(30) Foreign Application Priority Data
Aug. 24, 2021 (TW) 110131297

(51) Int. Cl. G02B 5/20; G02B 27/00; C03C 4/08; C03C 3/062

(52) U.S. Cl. CPC G02B 5/208; C03C 3/062; C03C 4/082; G02B 27/0018; C03C 2204/00

(57) ABSTRACT

A near-infrared absorbing glass is provided and includes 10% to 40% by weight of phosphorus and 5% to 35% by weight of iron, where a molar ratio of phosphorus to iron (P/Fe) of the near-infrared absorbing glass is between 1.75 and 5, and the near-infrared absorbing glass has an average transmittance of less than 10% to light with wavelengths ranging from 930 nm to 950 nm. A near-infrared cut-off filter including the near-infrared absorbing glass is also provided.

### BACKGROUND

### 1. Technical Field

The present disclosure relates to a near-infrared absorbing glass and a near-infrared cut-off filter comprising the same, and more particularly, to a near-infrared cut-off filter with thin thickness, high visible light transmittance and high near-infrared cutoff.

### 2. Description of Related Art

With the evolution of technology, the market’s standards for images have gradually raised, and the optical characteristics of camera elements have become more and more stringent. In addition to the previous miniaturization of light, thin, short, and small, the function of night shooting has also been valued. Shooting in places with insufficient light naturally requires higher sensitivity to visible light. In order to meet the requirements, the filter needs to be improved, especially the transmittance of visible light close to the infrared region must be improved.

On the other hand, with the development of biometric technology, various products on the market, such as mobile phones and other devices, begin to arrange biometric elements around the camera element. However, because the biometric element uses light with a wavelength of 940 nm as an infrared light source, and due to the miniaturization of the device, the biometric element is often very close to the camera element, so the infrared light of the wavelength of 940 nm would seriously affect the imaging quality of the camera element. It is necessary to require the improvement of the filter.

### SUMMARY

In order to achieve the above objective, a first aspect of the present disclosure provides a near-infrared absorbing glass, comprising: 10% to 40% by weight of phosphorus and 5% to 35% by weight of iron, wherein a molar ratio of the phosphorus to the iron of the near-infrared absorbing glass is between 1.75 and 5, and an average transmittance of the near-infrared absorbing glass to light with wavelengths ranging from 930 nm to 950 nm is less than 10%.

In at least one embodiment, the near-infrared absorbing glass has a thickness of 0.3 mm or less. In another embodiment, the thickness of the near-infrared absorbing glass is 0.2 mm or less.

In at least one embodiment, the near-infrared absorbing glass has the average transmittance of more than 80% for light with wavelengths ranging from 420 nm to 650 nm. In another embodiment, the average transmittance of the near-infrared absorbing glass to light with wavelengths ranging from 420 nm to 650 nm is greater than 85%, for example, when the thickness of the near-infrared absorbing glass is 0.2 mm or less.

In at least one embodiment, the molar ratio of the phosphorus to the iron is between 2 and 4 or between 2.5 and 3.5.

In at least one embodiment, an iron content of the near-infrared absorbing glass is between 10% and 25% by weight.

In at least one embodiment, the near-infrared absorbing glass further comprises 0.1% to 10% by weight of silicon, 1% to 20% by weight of aluminum, 0% to 10% by weight of an alkali metal, and a total of 0.1% to 20% by weight of alkaline earth metals and other divalent elements.

In at least one embodiment, the alkaline earth metals and the other divalent elements are at least one selected from a group consisting of magnesium, calcium, strontium, barium and zinc. In another embodiment, the alkaline earth metals are magnesium and calcium, and the other divalent element is zinc.

In at least one embodiment, a semi-penetration wavelength (T50%) of the near-infrared absorbing glass is 700 nm or more, 730 nm, between 730 nm and 800 nm, or between 750 nm and 800 nm. Incidentally, in the present disclosure, the semi-penetration wavelength (T50%) means the wavelength value (unit is in nm) when the transmittance of light in the near-infrared region to the glass or filter is 50 %.

In at least one embodiment, a transmittance of the near-infrared absorbing glass to light with a wavelength of 940 nm is less than 10 %.

In at least one embodiment, the average transmittance of the near-infrared absorbing glass to light with wavelengths of 420 nm to 650 nm is greater than 80% or greater than 85%.

A second aspect of the present disclosure further provides a near-infrared cut-off filter, which includes the near-infrared absorbing glass of the first aspect and a multi-layer film structure, wherein the multi-layer film structure is at least one selected from a group consisting of a near-infrared absorbing film, an absorbing dye layer, an anti-reflection film and an infrared reflective film, and the near-infrared cut-off filter has a thickness of 0.3 mm or less.

In at least one embodiment, the thickness of the near-infrared cut-off filter is 0.2 mm or less.

In at least one embodiment, a semi-penetration wavelength of the near-infrared cut-off filter is 630 nm or more, or between 640 nm and 660 nm.

In at least one embodiment, an optical blocking density value of the near-infrared cut-off filter for light with a wavelength of 940 nm is greater than 5.

In at least one embodiment, a transmittance of the near-infrared cut-off filter to light with a wavelength of 700 nm is less than 5%.

In at least one embodiment, the average transmittance of the near-infrared cut-off filter to light with wavelengths from 420 nm to 650 nm is greater than 85%.

In at least one embodiment, the near-infrared absorbing film includes a resin substrate, an organometallic complex and a dispersant, and the resin substrate is at least one selected from the group consisting of silicone resin (siloxane resin), epoxy resin, polyurethane, polyacrylate, polyolefin, polycarbonate, polycycloolefin and polyvinyl butyral.

In at least one embodiment, the absorbing dye layer is a near-infrared absorbing dye layer, an ultraviolet absorbing dye layer, or a near-infrared/ultraviolet composite absorbing dye layer.

In at least one embodiment, the absorbing dye layer includes an organic dye that absorbs near-infrared rays, which is at least one selected from a group consisting of azo compounds, diimide compounds, dithiol metal complexes, phthalocyanine compounds, squaraine compounds and cyanine compounds.

In at least one embodiment, the absorbing dye layer includes an organic dye that absorbs ultraviolet rays, which is at least one selected from a group consisting of ketone type ultraviolet absorbers, benzimidazole type ultraviolet absorbers and triazine type ultraviolet absorbers.

In at least one embodiment, a material of the anti-reflection film and the infrared reflective film is at least one selected from a group consisting of TiO₂, SiO₂, Y₂O₃, MgF₂, Al₂O₃, Nb₂O₅, AlF₃, Bi₂O₃, Gd₂O₃, LaF₃, PbTe, Sb₂O₃, SiO, SiN, Ta₂Os, ZnS, ZnSe, ZrO₂ and Na₃AlF₆.

The near-infrared absorbing glass of the present disclosure has excellent visible light transmittance and a wider near-infrared region transmittance band under the condition of thin thickness, and the semi-penetration wavelength can be increased to within a range of 730 nm to 800 nm. Therefore, the near-infrared cut-off filter made of the near-infrared absorbing glass is suitable for use in situations of insufficient light (such as dark places and nights). Blue glass (a kind of near-infrared absorbing glass) commonly used in the market has a semi-penetration wavelength that is usually between 620 nm and 635 nm, resulting in that the visible light near the infrared region has only a low transmittance; and while semi-penetration wavelength of the common heat-absorbing glass can be increased to 750 nm, the thickness of the heat-absorbing glass must be 0.5 mm to 3 mm to achieve the spectral characteristics of the present disclosure, which cannot be achieved with a thin thickness as the present disclosure.

On the other hand, although the semi-penetration wavelength of the near-infrared absorbing glass of the present disclosure is increased, the near-infrared rays can still be blocked, for example, the transmittance of light of 940 nm is less than 10 %. Subsequently, a multi-layer film structure is added on the near-infrared absorbing glass to enhance the near-infrared cutoff, so that the near-infrared cut-off filter of the final product achieves thin thickness, high visible light transmittance and high near-infrared cutoff. Eventually, an optical blocking density value of light of 940 nm can be greater than 5, greater than 6, or even greater than 7, which can avoid the interference of biometric components near the camera element. Moreover, it has been tested that the offset of wavelength and transmittance under different light incident angles is small, which effectively reduces the generation of flare and ghost images.

In addition, since the near-infrared absorbing glass of the present disclosure itself has excellent optical properties, when the process of adding a multi-layer film structure is added subsequently, the process complexity can be improved, such as relaxing the requirements of the coating, etc., thereby reducing the process difficulty.

### BRIEF DESCRIPTION OF THE DRAWINGS

FIG. 1 is a transmittance spectrum of Embodiments 1 to 5 and Comparative Example 1 of a near-infrared absorbing glass according to the present disclosure to light with a wavelength of 350 nm to 1100 nm.

FIG. 2 is a transmittance spectrum of Embodiment 6 and Comparative Example 2 of a near-infrared cut-off filter according to the present disclosure to light with a wavelength of 350 nm to 1100 nm.

FIG. 3 is a transmittance spectrum of Embodiment 7 and Comparative Example 3 of a near-infrared cut-off filter according to the present disclosure to light with a wavelength of 350 nm to 1100 nm.

FIG. 4 is a transmittance spectrum of Embodiment 8 and Comparative Example 4 of a near-infrared cut-off filter according to the present disclosure to light with a wavelength of 350 nm to 1100 nm.

FIG. 5 is a transmittance spectrum of Embodiment 9 and Comparative Example 5 of a near-infrared cut-off filter according to the present disclosure to light with a wavelength of 350 nm to 1100 nm.

### DETAILED DESCRIPTIONS

The following describes the implementation of the present disclosure with examples. Those skilled in the art can easily understand the spirit, advantages and effects of the present disclosure from the content disclosed in this specification. However, the embodiments set forth herein are not intended to limit the present disclosure, and the present disclosure can also be implemented or applied by other different embodiments, and the details set forth herein can also be based on different viewpoints and applications. Various changes or modifications can be made without departing from the spirit of the present disclosure.

When “comprising,” “including,” or “having” an element described herein, unless otherwise specified, other elements, components, structures, regions, parts, devices, systems, steps, or connection relationships and other requirements may be further included, rather than excluding those other requirements.

Terms such as “upper” and “lower” described herein are for the convenience of illustrating embodiments of the present disclosure, rather than for limiting the scope of the present disclosure, and the adjustment, exchange and change of their relative positions and relationships should be regarded as the scope in which the present disclosure can be practiced under the circumstances that do not substantially change the technical content of the present disclosure.

The singular forms “a” and “the” described herein also include the plural forms unless the context clearly dictates otherwise, and “or” is used interchangeably with “and/or” as used herein.

The numerical ranges described herein are inclusive and combinable, and any numerical value falling within the numerical range described herein can be taken as a maximum or minimum value to derive a subrange; for example, a numerical range of “phosphorus iron molar ratio (P/Fe) is between 1.75 and 5” should be understood to include any sub-range between a minimum value of 1.75 and a maximum value of 5, for example: 1.75 to 4, 2 to 5, and 2.5 cm to 3.5 cm and other sub-ranges; and, if a value falls within each range described herein (e.g., between the maximum and minimum values stated), it shall be deemed to be included in the present disclosure.

As used herein, “phosphorus iron molar ratio” refers to the molar ratio of the phosphorus element obtained from the phosphorus oxide in the raw material to the iron element obtained from the iron oxide in the raw material when making glass. Taking Embodiment 3 described later as an example, assuming that all oxides in the glass add up to 100 mol%, of which P₂O₅ accounts for 58.90 mol, and Fe₂O₃ accounts for 14.32 mol. Therefore, the phosphorus element of P₂O₅ is 117.80 mol in total, and the iron element of Fe₂O₃ is 28.64 mol in total. After calculation, it can be known that the molar ratio of phosphorus to iron in Embodiment 3 is 4.11.

A first aspect of the present disclosure is a near-infrared absorbing glass comprising 10% to 75% by weight of phosphorus and 5% to 35% by weight of iron. In one embodiment, 10% to 40% by weight of phosphorus and 5% to 35% by weight of iron are included. For instance, the infrared absorbing glass includes 10% to 40% by weight of phosphorus, 0.1% to 10% by weight of silicon, 1% to 20% by weight of aluminum, 5% to 35% by weight of iron, 0% to 10% by weight of alkali metals and a total of 0.1% to 20% by weight of alkaline earth metals and other divalent elements. The content of phosphorus can be, for example, 10, 15, 20, 25, 30, 35, 40, 45, 50, 55, 60, 65, 70, or 75% by weight; the content of silicon can be, for example, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, or 10% by weight; the content of aluminum can be, for example, 1, 2, 3, 4, 5, 6, 7, 8 , 9, 10, 11, 12, 13, 14, 15, 16, 17, 18, 19, or 20% by weight; the iron content is 5% to 35% by weight, 10% to 35% by weight, or 10% to 30% by weight, such as 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35% by weight; the content of alkali metals can be, for example, 0, 1, 2, 3, 4, 5, 6, 7, 8, 9, or 10% by weight; the total content of alkaline earth metals and other divalent elements can be, for example, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, or 20% by weight, but the present disclosure is not limited to as such.

In at least one embodiment, the present disclosure controls the phosphorus iron molar ratio (P/Fe) of the near-infrared absorbing glass to be between 1.75 and 5, between 2 and 5, between 3 and 5, between 2 and 4, or between 2.5 and 3.5. For example, the phosphorus iron molar ratio (P/Fe) can be 1.75, 1.78, 2, 2.25, 2.5, 2.51, 2.75, 2.98, 3, 3.05, 3.25, 3.5, 3.75, 4, 4.11, 4.25, 4.5, 4.75, 4.98, or 5, but the present disclosure is not limited to as such.

In the present disclosure, the alkali metal is selected from at least one of lithium, sodium and potassium. In some embodiments, the near-infrared absorbing glass of the present disclosure is substantially free of alkali metals. The alkaline earth metals and other divalent elements are at least one selected from the group consisting of beryllium, magnesium, calcium, strontium, barium, zinc, cobalt, neodymium, germanium, tin and cerium, or at least one selected from a group consisting of magnesium, calcium, strontium, barium and zinc, or alkaline earth metals are calcium and magnesium, and other divalent elements are zinc.

In at least one embodiment, the near-infrared absorbing glass of the present disclosure may further include 0% to 10% by weight of boron, and the content of boron may be 0, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, or 10% by weight. In at least one embodiment, the near-infrared absorbing glass of the present disclosure is substantially free of boron.

In at least one embodiment, the near-infrared absorbing glass of the present disclosure may further include other components. In at least one embodiment, the near-infrared absorbing glass of the present disclosure is substantially free of fluorine. In at least one embodiment, the near-infrared absorbing glass of the present disclosure is substantially free of copper.

In order to form the near-infrared absorbing glass having the above-mentioned components and content ranges, metaphosphates, carbonates, oxides, fluorides and the like can be selected as glass raw materials. The metaphosphates are such as aluminum metaphosphate, lithium metaphosphate, sodium metaphosphate, potassium metaphosphate, magnesium metaphosphate, zinc metaphosphate and calcium metaphosphate; the carbonates are such as sodium carbonate, potassium carbonate, magnesium carbonate, calcium carbonate; the oxides are such as P₂O₅, Fe₂O₃ (iron oxide), ferrous oxide, aluminum oxide, zinc oxide, alkaline earth metal oxides such as calcium oxide and magnesium oxide, boron oxide, silicon dioxide and alkali metal oxides. The process of converting glass raw materials into glass can be done by conventional methods, such as mixing each glass raw material uniformly in a certain proportion and placing it in a crucible, then placing the crucible in a reducing atmosphere furnace, and controlling the temperature of the reducing atmosphere furnace to be between 1200° C. and 1500° C., then the molten glass is stirred, clarified, flowed out of a casting mold and annealed to form, and finally a homogenized phosphate glass is obtained.

The near-infrared absorbing glass of the present disclosure has excellent transmittance in the visible light region when the thickness is thin (e.g., 0.3 mm or less), and a semi-penetration wavelength falls between 730 nm and 800 nm. Such spectral properties can be achieved by controlling a molar ratio of phosphorus to iron and/or an iron content in the glass. In at least one embodiment, the iron is divalent iron (turquoise), which can be provided by a ferrous oxide glass raw material.

In the prior art, if the iron content in the glass is low, the divalent iron can be formed directly in an isolated environment without using a reducing agent, and the glass manufacturing process can be conducted at a relatively low temperature (for example, below 1000° C.). When the iron content in the glass increases, a small amount of reducing agent needs to be added to help reduce the iron ions to avoid the formation of trivalent iron. On the other hand, when the prior art increases the iron content according to requirements, due to many difficulties in the manufacturing process, the iron content is often limited to not more than 10 mol%. In other words, when the iron content is not more than 10 mol%, a good reduction effect can be achieved without adding a reducing agent or only adding a small amount of reducing agent, and it is easy to obtain a blue-green glass mainly containing divalent iron, rather than a brown glass containing trivalent iron. However, due to the low iron content, the glass must be thicker than a certain level (e.g., above 1 mm) to have sufficient spectral properties.

With the requirement of glass thinning, the iron content in the glass must be increased (for example, the iron content is greater than 10 mol%). However, in this case, the reducibility of glass is insufficient, and the amount of reducing agent (such as carbon, glucose, etc.) is also increased. At this time, the ratio of the glass raw material must be adjusted with the reducing agent, and the amount of the reducing agent used has an upper limit. Adding too much reducing agent would cause the glass to crystallize. In order to achieve a sufficient reduction effect, the process may be further adjusted, for example, a reducing agent of a reducing gas (such as a nitrogen-hydrogen mixed gas) may be additionally given to ensure that divalent iron is obtained. Moreover, the high iron content also makes the glass manufacturing process need to be carried out at a higher temperature (for example, above 1300° C.), and the process requirements become higher. In addition, when the iron content in the glass is too high (e.g., higher than 30 mol%), the glass is prone to crystallize and difficult to form, and even using a reducing agent cannot provide sufficient reducing power, resulting in a large amount of undesired trivalent iron.

The present disclosure can obtain divalent iron stably under suitable glass compositions and reducing conditions after many trials, for instance, the molar ratio of phosphorus to iron and/or iron content in the glass are in a certain range. In at least one embodiment, the iron oxide content in the glass can be controlled to be more than 10 mol%, more than 12 mol%, or more than 15 mol%, and less than 30 mol%, less than 26 mol%, or less than 24 mol%, such as 10, 11, 11.12, 12, 13, 14, 14.32, 15, 16, 17, 18, 19, 19.32, 20, 20.18, 21, 22, 23, 23.48, 24, 25, 26, 27, 28, 29, 29.98, 30 mol%.

In at least one embodiment, the near-infrared absorbing glass is thin (e.g., the near-infrared absorbing glass is of a thin type), and its thickness is less than 0.3 mm, less than 0.2 mm, or between 0.1 mm and 0.3 mm, such as 0.3, 0.25, 0.2, 0.15, or 0.1 mm, but the present disclosure is not limited to as such. Generally speaking, the thinner the thickness of the near-infrared absorbing glass, the worse the near-infrared absorption effect. Therefore, the thickness of the near-infrared cut-off filter on the market is usually limited by the thickness of the near-infrared absorbing glass and is between 0.3 mm and 0.5 mm. In contrast, the near-infrared absorbing glass of the present disclosure has excellent optical properties even with a thin thickness.

The near-infrared absorbing glass of the first aspect of the present disclosure has excellent optical properties, and its semi-penetration wavelength (T50%) is closer to the near-infrared region than the conventional blue glass. The semi-penetration wavelength (T50%) of the near-infrared absorbing glass of the present disclosure is at least 700 nm or more, between 730 nm and 800 nm, or between 750 nm and 800 nm, such as 730, 735, 740, 745, 750, 755, 760, 765, 770, 775, 780, 785, 790, 795, or 800 nm, but the present disclosure is not limited to as such. Therefore, the light in the entire visible light region maintains high transmittance, which can be expressed as the average transmittance of light with wavelengths from 420 nm to 650 nm is greater than 80%, or greater than 85%, such as 81%, 82%, 83%, 84%, 85%, 86%, 87%, 88%, 89%, or 90%, but the present disclosure is not limited to as such.

Although the semi-penetration wavelength (T50%) of the near-infrared absorbing glass of the present disclosure is high, it still has a better absorption capacity for near-infrared rays. For instance, the near-infrared absorbing glass of the present disclosure has a transmittance of less than 10% for light with a wavelength of 940 nm, and an average transmittance of less than 10% for light with wavelengths between 930 nm and 950 nm, such as 9.5%, 9%, 8.5%, 8%, 7.5%, 7%, 6.5%, 6%, 5.5%, 5%, 4.5%, 4%, 3.5%, 3%, 2.5%, 2%, 1.5%, or 1%, but the present disclosure is not limited to as such.

A second aspect of the present disclosure provides a near-infrared cut-off filter, which is made from the near-infrared absorbing glass of the first aspect.

The near-infrared cut-off filter of the second aspect of the present disclosure includes the near-infrared absorbing glass and a multi-layer film structure, wherein the multi-layer film structure is at least one selected from the group consisting of a near-infrared absorbing film, an absorbing dye layer, an anti-reflection film and an infrared reflective film.

The multi-layer film structure is formed on a surface of the near-infrared absorbing glass, for example, formed on one surface of the near-infrared absorbing glass, or formed on both surfaces of the near-infrared absorbing glass. Moreover, the multi-layer film structure can be formed by methods such as conventional dip coating, spray coating, spin coating, blade coating, roller coating, vapor deposition, or sputtering.

In at least one embodiment, the thickness of the near-infrared cut-off filter is less than 0.3 mm, less than 0.2 mm, or between 0.1 mm and 0.3 mm, such as 0.3, 0.25, 0.2, 0.15, or 0.1 mm, but the present disclosure is not limited to as such. Since the near-infrared absorbing glass already has excellent optical properties, the multi-layer film structure can be thinned or part of the multi-layer film structure can be omitted, so that the near-infrared cut-off filter still has excellent optical properties under the condition of thin thickness.

In at least one embodiment, the semi-penetration wavelength (T50%) of the near-infrared cut-off filter is between 640 nm and 660 nm, such as 640, 641, 642, 643, 644, 645, 646, 647, 648, 649, 650, 651, 652, 653, 654, 655, 656, 657, 658, 659, or 660 nm, but the present disclosure is not limited to as such. Since the semi-penetration wavelength of the near-infrared absorbing glass is high, when the spectrum is improved by the multi-layer film structure, the semi-penetration wavelength of the near-infrared cut-off filter can be high as well, so that the transmittance of visible light region is significantly improved. For instance, the average transmittance of the near-infrared cut-off filter for light with wavelengths of 420 nm to 650 nm is greater than 85%, such as 86%, 87%, 88%, 89%, or 90%, but the present disclosure is not limited to as such.

In at least one embodiment, an optical blocking density value (OD) of the near-infrared cut-off filter for light with a wavelength of 940 nm is greater than 5, greater than 6, or greater than 7, such as 5.1, 5.2, 5.3, 5.4, 5.5, 5.6, 5.7, 5.8, 5.9, 6, 6.5, 7, 7.5, or 8, but the present disclosure is not limited to as such. In at least one embodiment, the transmittance of the near-infrared cut-off filter to light with a wavelength of 700 nm is less than 5%, such as 4.5%, 4%, 3.5%, 3%, 2.5%, 2%, 1.5%, or 1%, but the present disclosure is not limited to as such. The above shows that the near-infrared cut-off filter of the present disclosure has excellent infrared cut-off capability.

In at least one embodiment, the near-infrared absorbing film includes a resin substrate, an organometallic complex and a dispersant, and the resin substrate is at least one selected from the group consisting of silicone resin (siloxane resin), epoxy resin, polyurethane, polyacrylate, polyolefin, polycarbonate, polycycloolefin and polyvinyl butyral. The near-infrared absorbing film can absorb near-infrared rays to further reduce the transmittance of near-infrared rays.

In at least one embodiment, the absorbing dye layer is a near-infrared absorbing dye layer, an ultraviolet absorbing dye layer, or a near-infrared/ultraviolet composite absorbing dye layer. The absorbing dye layer includes an organic dye that absorbs near-infrared rays, which is at least one selected from the group consisting of azo compounds, diimide compounds, dithiol metal complexes, phthalocyanine compounds, squaraine compounds and cyanine compounds, which can further reduce the transmittance of near-infrared rays. The absorbing dye layer includes an organic dye that absorbs ultraviolet rays, which is at least one selected from the group consisting of ketone type ultraviolet absorbers, benzimidazole type ultraviolet absorbers and triazine type ultraviolet absorbers, which can reduce the transmittance of near-ultraviolet rays.

In at least one embodiment, a material of the anti-reflection film and the infrared reflective film is at least one selected from the group consisting of TiO₂, SiO₂, Y₂O₃, MgF₂, Al₂O₃, Nb₂O₅, AlF₃, Bi₂O₃, Gd₂O₃, LaF₃, PbTe, Sb₂O₃, SiO, SiN, Ta₂Os, ZnS, ZnSe, ZrO₂ and Na₃AlF₆. In another embodiment, the anti-reflection film and the infrared reflective film can be obtained by alternately vapor-depositing TiO₂ and SiO₂ with a thickness of 10 nm to 200 nm.

The following describes the embodiments of the present disclosure, those skilled in the art can easily understand other advantages and effects of the present disclosure from the contents disclosed in this specification.

### EMBODIMENTS

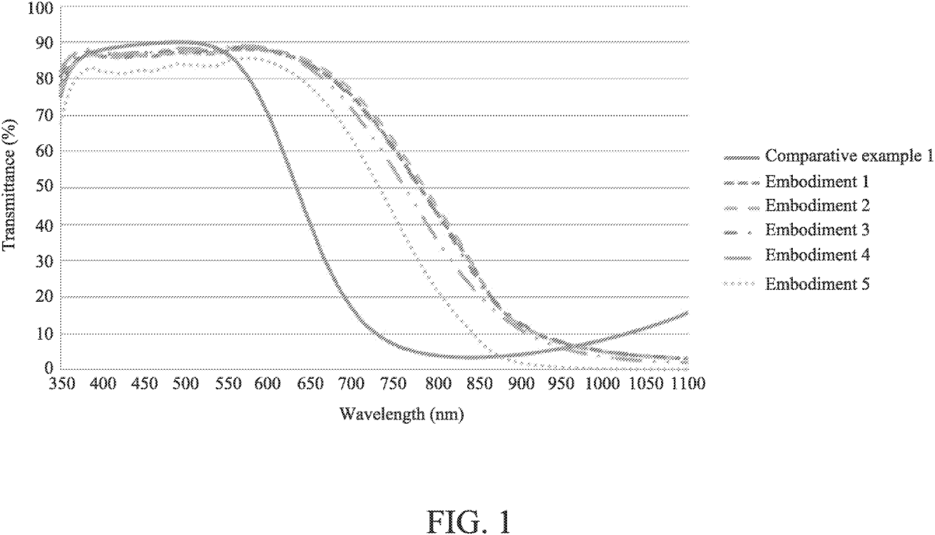

Please refer to Table 1, Table 2 and Table 3. Table 1 and Table 2 show the proportion of the main element oxides in the glass (expressed in % by weight and mol%), and Table 3 shows the proportion of the main element in the glass (expressed in % by weight). Weigh 100 g to 300 g of raw materials in proportion such as phosphates, metaphosphates and oxides corresponding to the glass components in the Tables, and mix them thoroughly and uniformly to obtain a glass raw material composition. The glass raw material composition is placed in a crucible, and then the crucible is placed in a reducing atmosphere furnace, and the temperature of the reducing atmosphere furnace is controlled between 1200° C. and 1500° C. Thereafter, the molten glass was stirred, clarified, flowed out of a casting mold, and annealed to obtain near-infrared absorbing glasses of Embodiments and Comparative Examples. Taking Embodiment 3 as an example, a thickness of the near-infrared absorbing glass is 0.2 mm. According to Table 1, the main element oxides of the glass of Embodiment 3 include 65.33% by weight of P₂O₅, 0.94% by weight of SiO₂, 11.15% by weight of Al₂O₃, 17.87% by weight of Fe₂O₃, 1.21% by weight of CaO, 1.57% by weight of MgO, 1.93% by weight of ZnO (4.71% by weight of alkaline earth metal oxides and other divalent element oxides in total). In addition, in Embodiment 3, P₂O₅ accounts for 58.9 mol%, so the total phosphorus element is 117.80 mol, and Fe₂O₃ accounts for 14.32 mol%, so the total iron element is 28.64 mol, and the molar ratio of phosphorus to iron is 4.11. On the other hand, according to Table 3, the main elements of the glass of Embodiment 3 include 28.51% by weight of phosphorus, 0.5% by weight of silicon, 6.05% by weight of aluminum, 12.78% by weight of iron, 0.89% by weight of calcium, 0.97% by weight of magnesium, 1.57% by weight of zinc (3.43% by weight of alkaline earth metals and other divalent elements in total). The glass compositions of other Embodiments 1, 2, 4, 5 and Comparative Example 1 are also shown in Table 1, Table 2 and Table 3, and the content ratio of phosphorus and iron is specially adjusted, wherein the definition and calculation method of phosphorus iron molar ratio are the same as those in the above-mentioned Embodiment 3, and will not be repeated here. The thickness and phosphorus iron molar ratio of each Embodiment and Comparative Example are shown in Table 4, wherein the molar ratio of phosphorus to iron of Embodiment 1 is about 1.78, and the thickness is 0.1 mm; the molar ratio of phosphorus to iron of Embodiment 2 is about 2.98, and the thickness is 0.15 mm; the molar ratio of phosphorus to iron of Embodiment 4 is about 4.98 and the thickness is 0.3 mm; the molar ratio of phosphorus to iron of Embodiment 5 is about 2.51, and the thickness is 0.2 mm; Comparative Example 1 does not add iron and has a thickness of 0.2 mm. FIG. 1 shows the transmittance spectrum of an embodiment of the near-infrared absorbing glass of the present disclosure, and the glass thickness and spectral data are shown in Table 5.

Table 1

| | | Al₂O₃ | ZnO | MgO | Fe₂O₃ | CaO | P₂O₅ | SiO₂ |
|---|---|---|---|---|---|---|---|---|
| Embodiment 1 | Mol% | 7.83 | 1.66 | 2.07 | 29.98 | 2.00 | 53.46 | 3.00 |
| | Wt% | 5.83 | 0.99 | 0.61 | 34.98 | 0.82 | 55.45 | 1.32 |
| Embodiment 2 | Mol% | 13.30 | 1.20 | 0.80 | 20.18 | 0.44 | 60.08 | 4.00 |
| | Wt% | 10.04 | 0.72 | 0.24 | 23.87 | 0.18 | 63.16 | 1.78 |
| Embodiment 3 | Mol% | 14.00 | 3.03 | 5.00 | 14.32 | 2.75 | 58.90 | 2.00 |
| | Wt% | 11.15 | 1.93 | 1.57 | 17.87 | 1.21 | 65.33 | 0.94 |
| Embodiment 4 | Mol% | 14.76 | 3.60 | 2.80 | 11.12 | 6.72 | 55.40 | 5.60 |
| | Wt% | 12.27 | 2.39 | 0.92 | 14.48 | 3.07 | 64.12 | 2.74 |
| Embodiment 5 | Mol% | 11.79 | 1.36 | 0.80 | 23.48 | 1.20 | 58.87 | 2.50 |
| | Wt% | 8.80 | 0.81 | 0.24 | 27.43 | 0.49 | 61.14 | 1.10 |

Table 2

| | | Al₂O₃ | MgO | CaO | P₂O₅ | AlP₃ | BaF₂ | CuO | Li₂O | ZnF₂ | BaO | SrF₂ |
|---|---|---|---|---|---|---|---|---|---|---|---|---|
| Comparative Example 1 | Mol% | 2.39 | 5.22 | 9.78 | 36.6 | 5.28 | 1.08 | 6.95 | 20.68 | 0.62 | 7.98 | 3.42 |
| | Wt% | 2.51 | 2.17 | 5.64 | 53.46 | 4.56 | 1.95 | 5.69 | 6.36 | 0.65 | 12.59 | 4.42 |

Table 3

| | | Al | Zn | Mg | Fe | Ca | P | Si | Others |
|---|---|---|---|---|---|---|---|---|---|
| Embodiment 1 | Wt% | 3.08 | 1.33 | 0.36 | 24.46 | 0.58 | 24.19 | 0.61 | 45.39 |
| Embodiment 2 | Wt% | 5.31 | 0.58 | 0.14 | 16.69 | 0.13 | 27.56 | 0.83 | 48.76 |
| Embodiment 3 | Wt% | 6.05 | 1.57 | 0.97 | 12.49 | 0.89 | 28.51 | 0.5 | 49.02 |
| Embodiment 4 | Wt% | 6.49 | 1.92 | 0.55 | 10.13 | 2.19 | 27.98 | 1.28 | 49.46 |
| Embodiment 5 | Wt% | 4.66 | 0.65 | 0.14 | 19.18 | 0.35 | 26.68 | 0.51 | 47.83 |
| Comparative Example 1 | Wt% | 2.79 | 0.41 | 1.31 | 0 | 4.03 | 23.33 | 0 | 68.13 |

Table 4

| | Embodiment 1 | Embodiment 2 | Embodiment 3 | Embodiment 4 | Embodiment 5 | Comparative Example 1 |
|---|---|---|---|---|---|---|
| Thickness | 0.1 mm | 0.15 mm | 0.2 mm | 0.3 mm | 0.2 mm | 0.2 mm |
| Phosphorus iron molar ratio | 1.78 | 2.98 | 4.11 | 4.98 | 2.51 | N/A |

Table 5

| | Embodiment 1 | Embodiment 2 | Embodiment 3 | Embodiment 4 | Embodiment 5 | Comparative Example 1 |
|---|---|---|---|---|---|---|
| Glass thickness (mm) | 0.1 | 0.15 | 0.2 | 0.3 | 0.2 | 0.2 |
| 420-650 nm Tavg% | 86.91 | 87.29 | 86.91 | 89.01 | 83.30 | 79.57 |
| 650 nm T% | 83.66 | 84.56 | 83.52 | 82.54 | 77.48 | 39.05 |
| T50% | 77991 | 784.91 | 784.19 | 799.41 | 731.21 | 632.00 |
| 930-950 nm Tavg% | 8.22 | 8.16 | 8.53 | 6.84 | 0.95 | 5.62 |
| 940 nm T% | 8.29 | 8.22 | 8.60 | 6.90 | 0.96 | 5.58 |

As can be seen from FIG. 1 and Table 5, the average transmittance values of Embodiment 1 to Embodiment 5 in the visible light region are greater than an average transmittance value of Comparative Example 1, because the semi-penetration wavelength of Comparative Example 1 is only as low as at 632.00 nm. The transmittance is greatly attenuated after 550 nm, that is, the transmittance of visible light from 550 nm to 760 nm is poor. However, the semi-penetration wavelength of Embodiment 1 to Embodiment 5 is as high as 730 nm or more, the spectrum shows that the transmittance in the visible light region almost maintains a plateau shape above 80%, and only gradually drops off after 650 nm.

On the other hand, although the near-infrared absorbing glass of the present disclosure has a semi-penetration wavelength of 730 nm or more, the transmittance to light with a wavelength of 940 nm can still be reduced to less than 10%, which is equivalent to Comparative Example 1, and would not increase the burden of the subsequent multi-layer film structure.

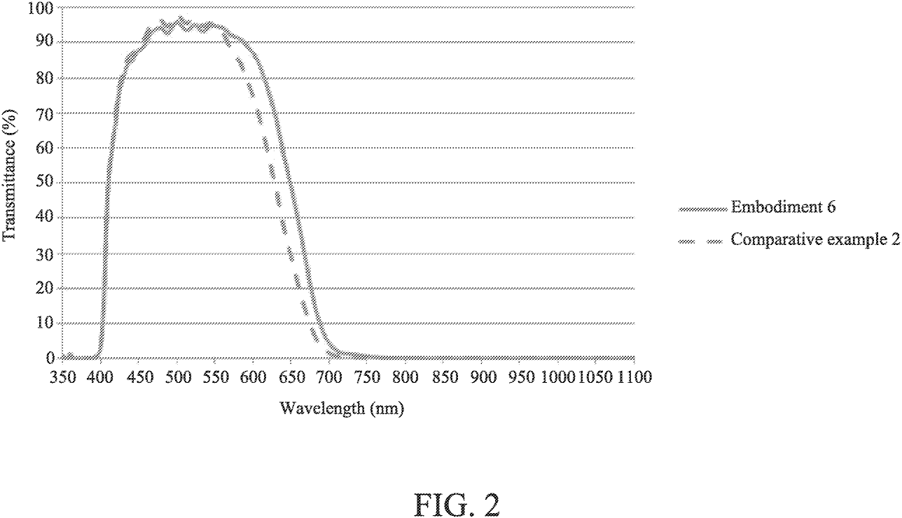

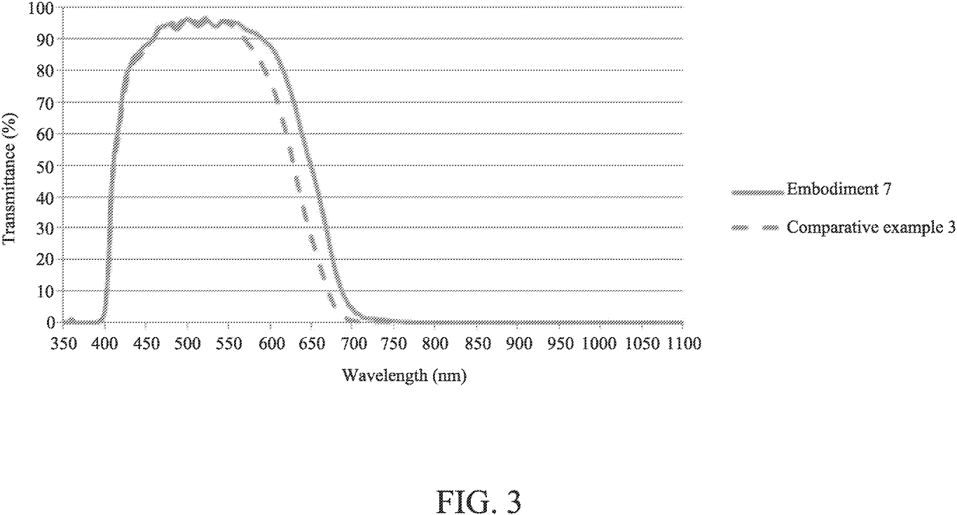

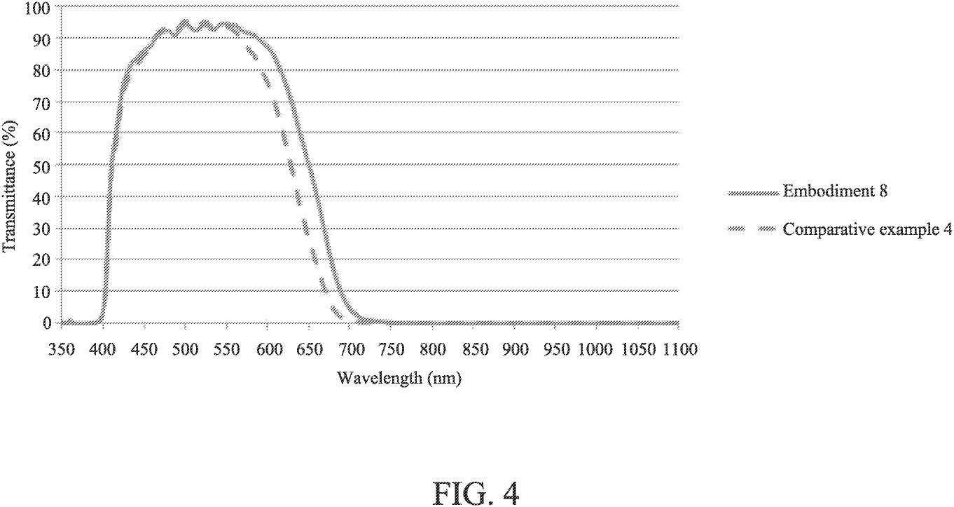

FIG. 2 to FIG. 5 are transmittance spectra of an embodiment of a near-infrared cut-off filter of the present disclosure, which can be obtained after adding a near-infrared absorbing film, an absorbing dye layer, an anti-reflection film and an infrared reflective film on the surface of the near-infrared absorbing glass.

Table 6

| | Embodiment 6 | Comparative Example 2 | Embodiment 7 | Comparative Example 3 | Embodiment 8 | Comparative Example 4 | Embodiment 9 (0 degrees) | Embodiment 9 (30 degrees) | Comparative Example 5 (0 degrees) | Comparative Example 5 (30 degrees) |
|---|---|---|---|---|---|---|---|---|---|---|
| Glass thickness (mm) | 0.15 | 0.15 | 0.09 | 0.09 | 0.09 | 0.09 | 0.15 | 0.15 | 0.15 | 0.15 |
| Filter thickness (mm) | 0.19 | 0.19 | 0.15 | 0.15 | 0.20 | 0.20 | 0.19 | 0.19 | 0.19 | 0.19 |
| 420-650 nm Tavg% | 86.64 | 82.49 | 87.19 | 82.14 | 85.98 | 80.71 | 85.76 | 85.13 | 78.79 | 79.63 |
| 700 nm % | 4.43 | 1.51 | 4.39 | 0.7 | 4.76 | 0.67 | 3.98 | 0.43 | 0.94 | 0.06 |
| 940 nm (OD) | 5.56 | 5.93 | 5.68 | 5.9 | 7.15 | 7.38 | 6.15 | 5.21 | 5.8 | 4.8 |
| T50% | 648 | 628 | 649 | 628 | 650 | 628 | 647 | 644 | 626 | 624 |

As can be seen from FIG. 2 to FIG. 5 and Table 6, the near-infrared cut-off filters of Embodiment 6 to Embodiment 9 have better transmittance in the visible light region because the semi-penetration wavelengths of Embodiment 6 to Embodiment 9 are between 648 nm and 650 nm, its visible light transmittance between 550 nm and 700 nm is better than Comparative Example 2 to Comparative Example 5. On the other hand, Embodiment 6 to Embodiment 9 show that the cutoff properties of the near-infrared rays are equivalent to the cutoff properties of Comparative Example 2 to Comparative Example 5, and are not degraded by increasing the semi-penetration wavelength.

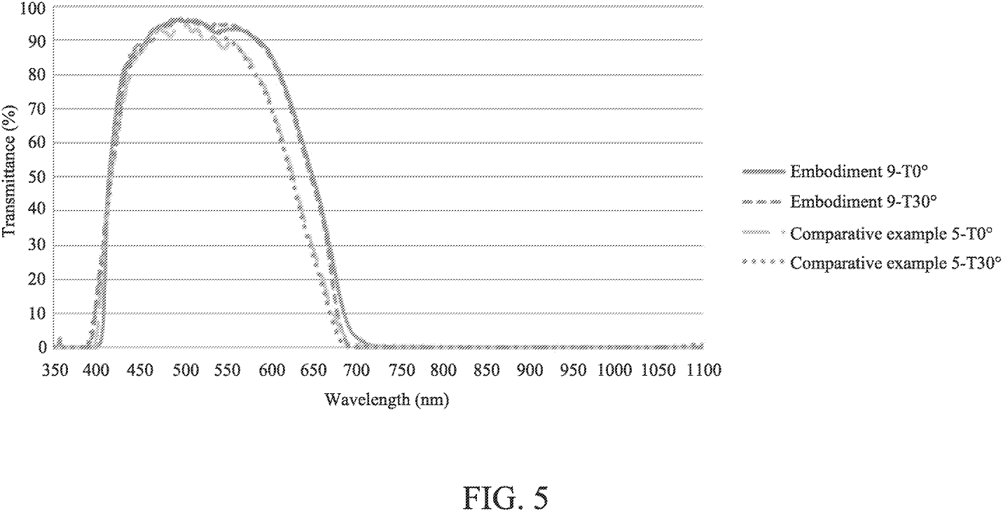

Looking at Embodiment 9 of FIG. 5 again, it is shown that visible light irradiates the near-infrared cut-off filter at an angle of 0 degrees and an angle of 30 degrees, respectively. Regardless of the Embodiment or the Comparative Example, the similarity between the two angles of the spectrogram is extremely high, that is, the wavelength offset and the transmittance offset are low, which can reduce the possibility of flare and ghost images during imaging. It can be seen that the near-infrared cut-off filter of the present disclosure is not degraded by increasing the semi-penetration wavelength of the near-infrared absorbing glass.

What is claimed is:

1. A near-infrared absorbing glass, comprising:
10% to 40% by weight of phosphorus; and
5% to 35% by weight of iron,
wherein a molar ratio of the phosphorus to the iron of the near-infrared absorbing glass is between 1.75 and 5, and an average transmittance of the near-infrared absorbing glass to light with wavelengths ranging from 930 nm to 950 nm is less than 10%.

2. The near-infrared absorbing glass of claim 1, wherein the near-infrared absorbing glass has a thickness of 0.3 mm or less.

3. The near-infrared absorbing glass of claim 2, wherein the thickness of the near-infrared absorbing glass is 0.2 mm or less.

4. The near-infrared absorbing glass of claim 1, wherein the average transmittance of the near-infrared absorbing glass to light with wavelengths ranging from 420 nm to 650 nm is greater than 80%.

5. The near-infrared absorbing glass of claim 3, wherein the average transmittance of the near-infrared absorbing glass to light with wavelengths ranging from 420 nm to 650 nm is greater than 85%.

6. The near-infrared absorbing glass of claim 1, wherein the molar ratio of the phosphorus to the iron is between 2 and 4.

7. The near-infrared absorbing glass of claim 6, wherein the molar ratio of the phosphorus to the iron is between 2.5 and 3.5.

8. The near-infrared absorbing glass of claim 1, wherein the near-infrared absorbing glass includes 10% to 25% by weight of the iron.

9. The near-infrared absorbing glass of claim 1, wherein the near-infrared absorbing glass has a semi-penetration wavelength of 700 nm or more.

10. The near-infrared absorbing glass of claim 9, wherein the semi-penetration wavelength of the near-infrared absorbing glass is between 730 nm and 800 nm.

11. The near-infrared absorbing glass of claim 1, further comprising:
0.1% to 10% by weight of silicon;
1% to 20% by weight of aluminum;
0% to 10% by weight of an alkali metal; and
a total of 0.1% to 20% by weight of alkaline earth metals and other divalent elements.

12. The near-infrared absorbing glass of claim 11, wherein the alkaline earth metals and the other divalent elements are at least one selected from a group consisting of magnesium, calcium, strontium, barium and zinc.

13. The near-infrared absorbing glass of claim 12, wherein the alkaline earth metals are magnesium and calcium, and the other divalent element is zinc.

14. A near-infrared cut-off filter, comprising the near-infrared absorbing glass of claim 1 and a multi-layer film structure, wherein the multi-layer film structure is at least one selected from a group consisting of a near-infrared absorbing film, an absorbing dye layer, an anti-reflection film and an infrared reflective film, and wherein the near-infrared cut-off filter has a thickness of 0.3 mm or less.

15. The near-infrared cut-off filter of claim 14, wherein the thickness of the near-infrared cut-off filter is 0.2 mm or less.

16. The near-infrared cut-off filter of claim 14, wherein the near-infrared cut-off filter has a semi-penetration wavelength of 630 nm or more.

17. The near-infrared cut-off filter of claim 16, wherein the semi-penetration wavelength of the near-infrared cut-off filter is between 640 nm and 660 nm.

18. The near-infrared cut-off filter of claim 14, wherein an optical blocking density value of the near-infrared cut-off filter for light with a wavelength of 940 nm is greater than 5.

19. The near-infrared cut-off filter of claim 14, wherein a transmittance of the near-infrared cut-off filter to light with a wavelength of 700 nm is less than 5%.

20. The near-infrared cut-off filter of claim 14, wherein the average transmittance of the near-infrared cut-off filter to light with wavelengths from 420 nm to 650 nm is greater than 85%.
